(19) United States
(12) Patent Application Publication
(10) Pub. No.: US 2025/0108451 A1
(43) Pub. Date: Apr. 3, 2025

(54) HYDROGEN PLASMA ARC ADDITIVE MANUFACTURING OF SUSTAINABLE IRON AND STEEL

(71) Applicant: UT-Battelle, LLC, Oak Ridge, TN (US)

(72) Inventors: Rangasayee Kannan, Oak Ridge, TN (US); Peeyush Nandwana, Oak Ridge, TN (US); Andrzej Nycz, Oak Ridge, TN (US); Adam Stevens, Oak Ridge, TN (US); Sudarsanam Suresh Babu, Knoxville, TN (US)

(21) Appl. No.: 18/897,917

(22) Filed: Sep. 26, 2024

Related U.S. Application Data
(60) Provisional application No. 63/541,119, filed on Sep. 28, 2023.

(51) Int. Cl. B23K 10/02; B33Y 10/00; B33Y 30/00

(52) U.S. Cl. CPC B23K 10/027; B33Y 10/00; B33Y 30/00

(57) ABSTRACT

A scalable method for the manufacture of iron and steel. The method includes hydrogen plasma arc additive manufacturing of near net shape steel and iron parts. More specifically, the method includes the hydrogen plasma reduction of iron ore concentrates using a plasma arc welding (PAW) torch and hydrogen and argon shielding gases. The plasma arc generated by the PAW torch and the hydrogen and argon shielding gases strip electrons from the feedstock, for example a ribbon comprising fine iron ore concentrates, as part of an additive build, thereby avoiding the need for post-processing operations such as casting, rolling, and forging operations.

### CROSS-REFERENCE TO RELATED APPLICATIONS

This application claims the benefit of U.S. Provisional Application 63/541,119, filed Sep. 28, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to the preparation of directly reduced iron and steel near net shape parts by hydrogen plasma arc additive manufacturing.

### BACKGROUND OF THE INVENTION

Iron and steel are the most used metals in many consumer applications, including the automotive and construction industries. In view of the pressing need for decarbonization and the need to reduce greenhouse gas emission by 80% around 2050, emphasis is being placed on the iron and steel industry to transition away from fossil fuel-based production methods. This is because 70% of globally produced iron and steel come from blast furnaces or basic oxygen furnaces that use carbon rich coke as the reducing agent. This results in about 2.1 tons of carbon dioxide per ton of iron and steel produced, which accounts for 7% of global greenhouse gas emissions. These estimates are projected to increase in coming decades unless a sustainable route for iron and steel production is successfully commercialized.

Much of the existing research on decarbonizing iron and steel production are focused on the sustainable production of iron and steel. Among the proposed solutions for cleaner iron and steel production, hydrogen-based reduction is the most feasible, considering its abundant availability. Apart of the abundance of hydrogen, hydrogen-based reduction of iron ore is also thermodynamically the most efficient process. However, the majority of research using a hydrogen-based reduction is at a laboratory scale. Accordingly, there remains a continued need for commercially scalable methods for the manufacture of iron and steel with minimal carbon emissions.

### SUMMARY OF THE INVENTION

An improved method of manufacture is provided. The method includes hydrogen plasma arc additive manufacturing of near net shape steel and iron parts directly from the iron ore concentrates. More specifically, the method includes the hydrogen plasma reduction of iron ore concentrates using a plasma arc welding (PAW) torch and a mixture of hydrogen and argon as the shielding gas. The plasma arc generated by the PAW torch and the shielding gas strips electrons from the hydrogen and argon which increases the reactivity of hydrogen. This hydrogen plasma can directly strip the oxygen from the ore concentrate, for example a ribbon comprising fine iron ore concentrates, as part of an additive build, thereby avoiding the need for post-processing operations such as casting, rolling, and forging. The additive build will enable reducing the process heat and transportation associated with downstream processing like rolling, forging, and machining, thereby helping reduce the GHG emissions indirectly. The additive build will be critical to ensure sustainability of downstream processes in the iron and steel sector.

In another embodiment, a system for the manufacture of near net-shape iron and steel parts is provided. The system includes a PAW torch that is operably coupled to a robot arm and that includes an electrode and a shielding nozzle. The electrode creates a plasma arc that builds the near net shape part layer by layer according to a three-dimensional computer model. The PAW torch directly reduces an iron ore concentrate feedstock as the near net shape part is formed on a substrate atop a water-cooled substrate support. The feedstock is optionally a ribbon comprising fine iron ore concentrates that are bonded using a silicon-based binder. The composition of the ribbon can be changed to enable the direct formation of a wide variety of steel compositions.

These and other features and advantages of the present invention will become apparent from the following description of the invention, when viewed in accordance with the accompanying drawings and appended claims.

### BRIEF DESCRIPTION OF THE DRAWINGS

FIG. 1 is a schematic diagram of a plasma arc welding torch for hydrogen plasma arc additive manufacturing of near net shape carbon neutral steel and iron parts.

FIG. 2 is a schematic diagram of a plasma arc welding torch for the manufacture of near net shape carbon neutral steel and iron parts.

### DETAILED DESCRIPTION OF THE CURRENT EMBODIMENT

As discussed herein, the current embodiment relates to a method for the manufacture of near net shape carbon neutral steel and iron parts. The method includes hydrogen plasma reduction of iron ore concentrates using a plasma arc welding (PAW) torch and hydrogen and argon shielding gases. The plasma arc strips away electrons from the feedstock without carbonaceous material as part of an additive build, while also avoiding the need for post-processing operations such as downstream casting, rolling, and forging.

Conventional blast furnaces involve a reduction of iron oxides to produce molten pig iron and slag. For iron ore, the primary chemical reaction that gives rise to molten iron can be described as Fe₂O₃+3CO→2Fe+3CO₂. Preheated blast air blown into the furnace reacts with carbon in the form of coke to produce carbon monoxide and heat. The carbon monoxide then reacts with the iron oxide to produce molten iron and carbon dioxide. Carbon dioxide and unreacted carbon monoxide are ultimately released from the blast furnace, contributing to 7% of global greenhouse gas emissions. As discussed below, the present invention instead involves the reduction of iron ore concentrates using a PAW torch, that is, reduction of iron ore concentrates by ionic hydrogen.

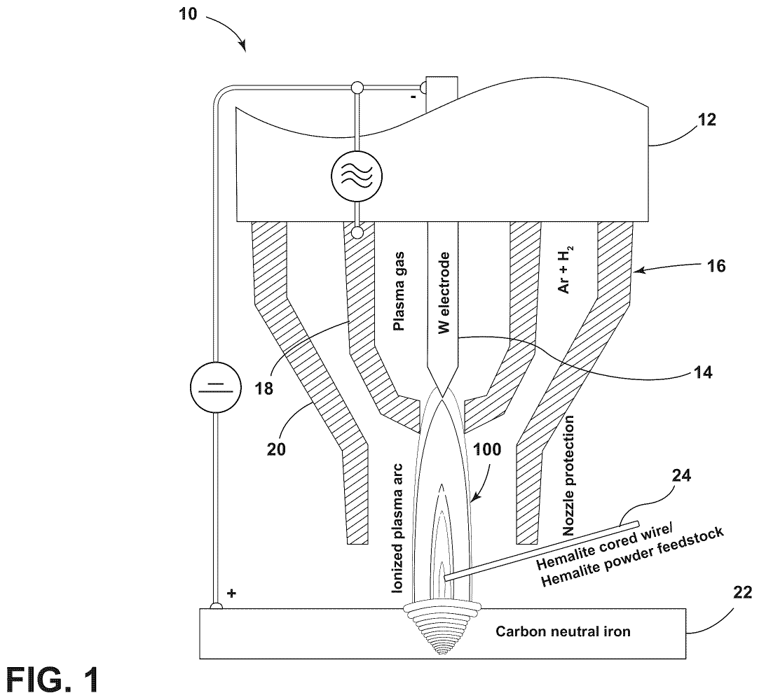

In particular, and with reference to FIG. 1, a PAW torch is illustrated and generally designated 10. The PAW torch 10 includes a torch body 12, a torch electrode 14, and a torch nozzle 16. The torch body 12 provides a primary housing for attachment of the PAW torch 10 to a robotic arm of an additive manufacturing system. The torch electrode 14 is formed from a refractory material that can withstand high temperatures and is responsible for creating the plasma arc 100. The torch nozzle 16 includes an inner nozzle 18 that surrounds the electrode 14 and constricts and focuses the plasma arc 100, creating a concentrated heat source. The torch nozzle 16 also includes an outer nozzle 20 that focuses the shielding gases. The outer nozzle 20 extends axially beyond the inner nozzle 18 and is disposed concentrically around the inner nozzle 18.

The PAW torch 10 is positioned above a substrate 22. A suitable feedstock 24 is positioned between the substrate 22 and the PAW torch 10. In one embodiment, the feedstock 24 includes a ribbon comprising fine iron ore concentrates that are bonded using a silicon-based binder. In operation, the shielding gases protect the additive build (i.e., the weld zone) from the surrounding atmosphere, while also controlling the shape and direction of the plasma arc, that is, ensuring that the plasma arc is highly focused on the additive build. In the illustrated embodiment, the shielding gases include argon and hydrogen.

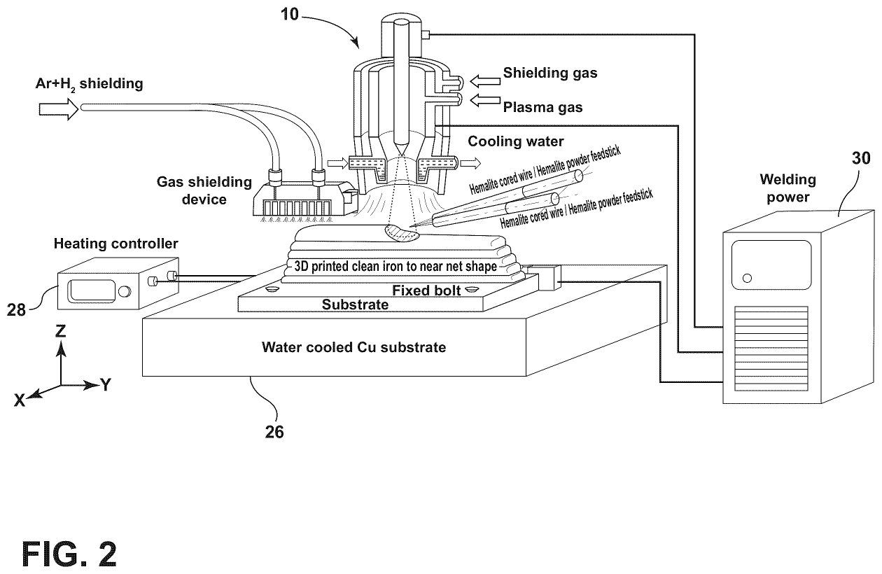

As more specifically shown in FIG. 2, the substrate 22 is supported atop a water cooled substrate support 26, the substrate support 26 optionally being comprised of copper. A heating controller 28 controls the temperature of the water cooled substrate support 26, while a welding controller 30 controls the operating parameters of the PAW torch 10. The operating parameters can include, for example, the power output of the PAW torch 10 and the flow rate of the shielding gases. Ionic hydrogen within the plasma arc 100 reduces the feedstock according to the following formula: Fe₂O₃+6H⁺+6e⁻→2Fe+3H₂O. When coupled to a robotic arm (or conversely, when the substrate support is integrated with a movable stage) of an additive manufacturing system, the PAW torch 10 can generate a near net-shape steel or iron part layer by layer according to a three-dimensional model of the final part, with each layer being a cross-section of the final part. Because iron and steel is reduced directly and only where needed, the method of the present invention significantly reduces material waste as compared to conventional manufacturing operations such as casting, rolling, and forging.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method for preparing directly reduced iron and steel near net shape parts, the method comprising:
positioning an iron oxide-containing feedstock between a metallic substrate and a plasma arc welding torch, the metallic substrate being supported by an actively-cooled substrate support, the plasma arc welding torch including a torch body, a torch electrode, and a torch nozzle; and
reducing the iron oxide-containing feedstock to form a first metal layer by exposing the iron ore concentrate-containing feedstock to a plasma arc from the torch nozzle, wherein the torch nozzle directs a hydrogen-containing shielding gas toward the iron oxide-containing feedstock;
wherein the torch body is coupled to a robotic arm of an additive manufacturing system and wherein the first metal layer is one of a plurality of metal layers of an additive build according to a three-dimensional computer model, such that the additive build is comprised of successive layers of directly reduced metal layers that are formed atop the metallic substrate.

2. The method of claim 1, wherein the actively-cooled substrate support includes copper.

3. The method of claim 1, wherein the actively-cooled substrate support includes a water-cooled copper substrate.

4. The method of claim 1, wherein the hydrogen-containing shielding gases include hydrogen and argon.

5. The method of claim 1, wherein the iron ore concentrate-containing feedstock includes a ribbon comprising iron ore concentrates and a silicon-based binder.

6. The method of claim 1, wherein reducing the iron ore concentrates-containing feedstock is performed without carbonaceous material to reduce carbon dioxide and carbon monoxide emissions.

7. The method of claim 1, wherein the additive build comprises a near net shape iron part or a near net shape steel part with no subsequent casting, rolling, or forging operations.

8. The method of claim 1, wherein the torch nozzle includes an inner nozzle that surrounds the torch electrode and that constricts and focuses the plasma arc.

9. The method of claim 8, wherein the torch nozzle includes an outer nozzle that focuses the hydrogen-containing shielding gas, wherein the outer nozzle extends axially beyond the inner nozzle and is disposed concentrically around the inner nozzle.

10. The method of claim 1, wherein the robotic arm is movable horizontally and vertically relative to the substrate support.

11. A system comprising:
a plasma arc welding torch positioned above an actively-cooled substrate support, the plasma arc welding torch including a torch body, a torch electrode, and a torch nozzle; and
a robotic arm of an additive manufacturing system coupled to the torch body of the plasma arc welding torch, wherein the plasma arch welding torch is operable to directly reduce an iron oxide-containing feedstock positioned on a metallic substrate above the actively-cooled substrate support, and wherein the torch nozzle directs a hydrogen-containing shielding gas toward the iron-oxide containing feedstock to form a first metal layer, the first metal layer comprising one of a plurality of metal layers of an additive build that is formed according to a three-dimensional model.

12. The system of claim 11, wherein the torch nozzle includes an inner nozzle that surrounds the torch electrode and that constricts and focuses a plasma arc.

13. The system of claim 12, wherein the torch nozzle includes an outer nozzle that focuses the hydrogen-containing shielding gas, wherein the outer nozzle extends axially beyond the inner nozzle and is disposed concentrically around the inner nozzle.

14. The system of claim 11, wherein the robotic arm is movable horizontally and vertically relative to the substrate support.

15. The system of claim 11, wherein the actively-cooled substrate support includes copper.

16. The system of claim 11, wherein the actively-cooled substrate support includes a water-cooled copper substrate.

17. The system of claim 11, wherein the hydrogen-containing shielding gases include hydrogen and argon.

18. The system of claim 11, wherein the iron ore concentrates-containing feedstock includes a ribbon comprising iron ore concentrates and a silicon-based binder.

19. The system of claim 11, wherein reducing the iron ore concentrates-containing feedstock is performed without carbonaceous material to reduce carbon dioxide and carbon monoxide emissions.

20. The system of claim 11, wherein the additive build comprises a near net shape iron part or a near net shape steel part with no subsequent casting, rolling, or forging operations.
